(19) United States
(12) Patent Application Publication
(10) Pub. No.: US 2026/0163132 A1
(43) Pub. Date: Jun. 11, 2026

(54) ENERGY SUPPLY DEVICE FOR AN ELECTRIC MACHINE AND METHOD OF PRODUCING AN ENERGY SUPPLY DEVICE FOR AN ELECTRIC MACHINE

(71) Applicant: ANDREAS STIHL AG & Co. KG, Waiblingen (DE)

(72) Inventors: Florian KLEIN, Esslingen am Neckar (DE); Armin GERBER, Waiblingen (DE); Christian UHLMANN, Uttenreuth (DE)

(73) Assignee: ANDREAS STIHL AG & Co. KG, Waiblingen (DE)

(21) Appl. No.: 19/179,914

(22) Filed: Apr. 15, 2025

(30) Foreign Application Priority Data
Apr. 15, 2024 (DE) 10 2024 110 496.1

(51) Int. Cl. H01M 50/145; H01M 10/48; H01M 50/213; H01M 50/24; H01M 50/503; H01M 50/516; H02K 11/00

(52) U.S. Cl. CPC H01M 50/145; H01M 10/488; H01M 50/213; H01M 50/24; H01M 50/503; H01M 50/516; H01M 2220/30; H02K 11/0094

(57) ABSTRACT

An energy supply device for an electric machine includes a plurality of cell units which can be contacted with each other. At least one cell unit of the plurality of cell units has at least one contact element for transmitting electrical energy, which is assigned to a contact area of the at least one cell unit. The at least one cell unit has at least one protective element which is formed from at least one reaction material. The at least one protective element is configured to form a connection with the at least one contact element and/or with the contact area, to shield at least one contact element section of the at least one contact element and/or at least one contact area section of the contact area from a medium of an environment of the energy supply device.

### CROSS-REFERENCE TO RELATED APPLICATIONS

This application claims priority under 35 U.S.C. § 119 to German patent application DE 10 2024 110 496.1, filed Apr. 15, 2024, the entire disclosure of which is incorporated herein by reference.

### BACKGROUND OF THE DISCLOSURE

### 1. Field of the Disclosure

The present disclosure is in the field of electrical energy supply technology and relates to an energy supply device for an electric machine, in particular a mobile and/or portable electric tool, and a method for producing an energy supply device for an electric machine.

### 2. Description of Related Art

Electric machines and energy supply devices for electric machines are used in different applications and environments and are exposed to the influences of a wide variety of media, which can, for example, impair electrical safety. An energy supply device in the form of a single accumulator or several accumulators, each with several cell units, for example lithium-ion cell units or sodium-ion cell units, a solid-state accumulator, a lithium battery, etc., must be both mechanically robust and resistant to media from the environment. For example, in the case of an electric machine in the form of a mobile, battery-operated cut-off machine, no dust or moisture can penetrate the energy supply device, for example in the area of the lithium-ion cell units. Integrated safety elements, such as a pressure relief valve or a current interruption device (CID) for interrupting the current when certain pressures (internal pressures) and/or temperatures are reached or exceeded, must always retain their functionality and must not be impaired.

Various approaches for protecting energy supply devices from media of the environment, such as moisture and dust, are known from the prior art patent literature, with reference being made here to the publications EP 3 982 473 A1, DE 10 2013 205 640 A1, DE 10 2011 078 301 A1, US 2013/0095356 A1, US 2016/0329549 A1 and US 2018/0053974 A1.

### SUMMARY OF THE DISCLOSURE

It is an object of the present disclosure to provide an energy supply device for an electric machine, which is characterized in particular by improved protection against the harmful effects of different media of an environment in which the energy supply device is located, so that, for example, the interior of the energy supply device is not endangered and other existing or current safety elements of the energy supply device are not impaired in their function. Furthermore, it is an object of the present disclosure to provide a method for producing an energy supply device which is characterized above all by improved assembly, in particular improved process reliability, so that, for example, no reworking is required, which is also associated with an increase in the effectiveness and quality of the method.

The object is solved by the features of the independent claims. Further embodiments and applications of the present disclosure result from the dependent claims and are explained in more detail in the following description with partial reference to the figures.

According to a first general aspect, the present disclosure relates to an energy supply device for an electric machine, in particular for a mobile, portable, manually operable and/or a self-sufficient (mains-independent) operable electric tool (“power tool”), comprising: a plurality of cell units which can be contacted with each other, at least one cell unit of the plurality of cell units comprises at least one contact element for transmitting electrical energy, which is assigned to a contact area of the at least one cell unit; wherein the at least one cell unit comprises at least one protective element, in particular at least one substantially dimensionally stable protective element, which is formed from at least one reaction material, in particular from at least one applied, physically reacted and/or chemically reacted reaction material, wherein the at least one protective element (itself) is configured to form a connection, in particular a material-locking connection, with the at least one contact element and/or with the contact area, in order to shield at least one contact element section of the at least one contact element and/or at least one contact area section of the contact area in each case from a medium, in particular a dispersion medium in an air, of an environment of the energy supply device, in particular to insulate it permanently.

The present disclosure can provide an electrical energy supply device which is characterized in particular by a more effective protection against a medium of the environment, especially at and/or in critical sections of the energy supply device for electrical energy transmission, for example during a charging process and/or a discharging process of the energy supply device. The energy supply device is thus characterized, for example, by increased electrical safety, especially during handling and/or during operation of an electric machine connected to the energy supply device. The at least one protective element and the connection formed by the at least one protective element (itself) can, for example, prevent the occurrence of corrosion and/or leakage currents in the energy supply device. In addition, this can also ensure a more even charge distribution between cell units of the plurality of cell units in order to prevent or at least significantly reduce uneven charge states (“debalancing”).

The energy supply device is, in particular, a mobile, exchangeable and/or portable energy supply device. The energy supply device is formed in particular as a rechargeable and/or pluggable accumulator. The plurality of cell units and/or the at least one cell unit can each be in the form of a lithium-ion cell unit (abbreviated to “lithium-ion cell”). The cell units can each be essentially identical to one another and/or be characterized by a standardized design, for example, by the design with the 18650 format or as a cuboid pouch cell.

The at least one contact element section and the at least one contact area section can adjoin and/or be formed directly (immediately) to each other. The at least one contact element section and the at least one contact area section can be part of the electrical connection area of the at least one cell unit. The contact area can comprise the at least one contact element at least in sections and/or the at least one contact element can define the contact area at least in sections, in particular (geometrically) delimit. In addition to the at least one contact element, the contact area can comprise further units and/or elements, for example, at least one safety element as disclosed herein, for example, in the form of a pressure relief valve and/or a current interruption device (abbreviated “CID”). The contact area can connect to and/or adjoin a reaction area, in particular a chemical reaction area, of the at least one cell unit.

The at least one protective element can be a passive protective element by which the energy supply device is additionally characterized alongside other existing or present safety elements. The at least one protective element can be a protective element produced on and/or at the at least one contact element section and/or at the least one contact area section. The at least one reaction material can be a reaction material converted during and/or after the production of the at least one protective element, in particular with respect to an aggregate state. The at least one reaction material can form the at least one protective element by at least one application process, in particular by at least one coating process, for example by means of a distribution tool for distributing the at least one reaction material.

This makes it possible, for example, for the at least one reaction material to be arranged at defined points of the at least one contact element section and/or the at least one contact area section, in particular at respective edges. Consequently, for example, a more exact or more precise shielding, in particular a sealing, of respective sections can be realized, which is improved, for example, compared to a shielding produced after dip coating. The at least one protective element is also characterized, for example, by a compact design so that, for example, (uncritical) ventilation of the energy supply device, in particular at the at least one cell unit, can continue to be ensured.

The energy supply device, in particular the at least one cell unit, can have a standardized configuration. The energy supply device, in particular the at least one cell unit, can be formed in accordance with a standard, ordinance, regulation, and/or a specification and/or can be based at least partially thereon.

The medium can be a harmful medium for the energy supply device and at least impair the functionality and/or safety of the energy supply device. The medium can, for example, be a liquid, liquid droplet-shaped, crystal-shaped, solid and/or fine-grained medium. For example, the at least one protective element can provide effective protection against dust and/or against water in various forms and states (dust protection, moisture protection). Additionally, or alternatively, the at least one protective element provides improved shielding from a dispersion medium, in particular in the form of a suspension as a heterogeneous mixture of substances with undissolved solid particles in a liquid medium (for example, water with coarse solid particles). A penetration of dust, dirt, and/or water, for example, into critical areas and/or sections of the energy supply device can be prevented or at least significantly and/or negligibly reduced.

According to a further aspect of the present disclosure, it can be provided that the at least one protective element is configured as a barrier, in particular as a layered and/or multilayered barrier, to prevent a passage of the medium through the at least one protective element to the at least one contact element section and/or to the at least one contact area section, in particular to electrically insulate the at least one contact element section and/or the at least one contact area section.

The barrier can be formed by the at least one reaction material as a multilayer composite and/or as a membrane (membrane-shaped). In this way, for example, a compact and at the same time material-saving design of the at least one protective element can be realized. In addition, various protective properties can be realized to implement the shielding function of the at least one protective element, for example, with regard to impermeability, resistance, etc.

It is possible that the at least one protective element comprises an active surface which faces and/or is assigned to the environment, wherein the active surface is configured to substantially repel the medium upon contact (with the medium), in particular to drain from the at least one protective element, or to substantially hold the medium.

The active surface can be characterized by a comparatively low and/or defined wettability so that, for example, a medium in the form of water drips or rolls off the at least one protective element. Furthermore, adhesion of dirt particles to and/or on the active surface can be minimized. Alternatively, it is possible that the active surface is configured to form a holding connection with the medium, for example in the form of an adhesive connection, but that the at least one protective element simultaneously retains its shielding function. The formed holding connection can be regenerated, for example, depending on temperature, air flow, regeneration medium, and the like.

According to a further aspect of the present disclosure, it can be provided that the at least one reaction material comprises at least one solvent component, wherein at least a part of the at least one solvent component is vaporizable and/or volatilizes depending on at least one of the following properties: a defined pressure, a defined temperature, a defined light quality, a defined period of time, and/or a defined humidity, in particular in a reaction chamber for producing the energy supply device or at least one component (for example device, unit and/or element) of the energy supply device; and/or that the at least one reaction material is essentially solvent-free.

The defined light quality can, for example, be characterized by a defined brightness, wavelength, and/or a defined light intensity. The defined light quality can, for example, be characterized by UV light.

It is possible that the at least one reaction material comprises at least one marking agent component configured for detection a shape, a pattern and/or a location of the at least one protective element, in particular, the at least one marking agent component is a fluorescent marking agent component (“UV tracer”). The at least one marking agent component can be configured to form a defined pattern on the at least one protective element, in particular to form an individual labelling of the at least one protective element.

The at least one marking agent component can be configured to absorb light, in particular UV light, and/or to emit and/or reflect light.

The at least one marking agent component as an additive to the at least one reaction material makes it possible to detect the geometric configuration and/or the location and thus the position and/or the orientation of the at least one protective element with sufficient accuracy, for example by means of a camera device of corresponding configuration.

Furthermore, a quality check and quality assurance can be realized for the at least one protective element, in particular whether sufficient shielding of relevant areas, in particular edges, of the at least one contact element section and/or the at least one contact area section is realized.

The detected shape, the detected pattern and/or the detected location of the at least one protective element can, for example, be evaluated by a machine learning method for image processing, in particular by an electronic image processing device with an arithmetic unit for executing at least one image processing algorithm.

Furthermore, depending in particular on the defined light quality, it can also be made possible, for example, that in the course of or during the production of the at least one protective element as disclosed herein, a defined zone, that is a defined area and/or a defined section of the at least one protective element is removed again from the at least one protective element, for example by washing it off, so that, for example, the functionality of existing or present safety elements is still guaranteed.

According to a further aspect of the present disclosure, it can be provided that the at least one protective element is configured to partially form an essentially force-locking connection, in particular a press connection, a predetermined breaking connection, and/or partially an essentially gas-permeable connection, in particular an air-permeable connection, with the at least one contact element section and/or with the at least one contact area section.

By forming an essentially force-locking connection, for example, robustness and the associated shielding function can be further improved, for example if mechanical loads occur, for example in the form of strokes, impacts and/or vibrations during handling of the energy supply device and/or during operation of the electric machine with the energy supply device.

By forming a predetermined breaking connection and/or an essentially gas-permeable connection in the at least one protective element, for example, an additional safety function can be realized in relation to the at least one cell unit.

It is possible that the at least one contact element is formed essentially flat, plate-shaped, curved, in particular cap-shaped, pin-shaped, strip-shaped, rail-shaped, beam-shaped, sleeve-shaped, and/or ring-shaped; and/or that the at least one protective element at least partially covers the at least one contact element in a circumferential direction, in particular at least up to an outer edge of the at least one contact element.

The at least one contact element can be formed as a so-called pole cap, for example for the positive pole, or as an essentially flat and/or plate-shaped cell connector. The at least one contact element can be formed as a stamped and/or bent part, in particular integrally in one piece. The at least one contact element and/or at least one further contact element can be formed as a cell housing of the at least one cell unit, for example for the negative pole. The at least one contact element and/or the at least one further contact element can define and/or limit the contact area (geometrically) at least in sections in the form of a cell housing.

According to a further aspect of the present disclosure, it can be provided that the at least one reaction material is applied, in particular coated, on and/or to the at least one contact element section, and/or on and/or to the at least one contact area section; and/or that the at least one reaction material is characterized by at least one of the following properties depending on a defined temperature of the at least one reaction material and/or depending on a defined pressure of the at least one reaction material: pourable, squirtable, sprayable, depositable, sublimable, shrinkable, hardenable, solidifiable, viscous, integrally one-piece, electrically insulating, substantially homogeneous, inhomogeneous, substantially dimensionally stable, and/or variable in shape.

The at least one reaction material can be a poured, squirted, sprayed, deposited, sublimated, shrunk, hardened, reacted, converted and/or a solidified reaction material for forming the at least one protective element. The at least one protective element can be formed essentially from the at least one reaction material and comprise a defined, essentially uniform and/or constant thickness.

The at least one reaction material of the at least one protective element can be at least one reaction material that has reacted with itself and/or has reacted with the at least one contact element section and/or has reacted with the at least one contact area section, with chemical and/or physical bonds and/or interactions being formed in each case.

The at least one reaction material can, for example, be an epoxy- and/or polyurethane- and/or acrylate- and/or ceramic- and/or silicone-based material. The at least one reaction material can be formed as a thermoplastic, thermoset and/or elastomer. The at least one reaction material can comprise a parylene and/or at least one derivative based on a parylene.

It is possible, for example, that the at least one protective element is formed by at least one oxidation process of the at least one reaction material.

The at least one reactive material can comprise at least one filler component, in particular at least one inactive (non-reactive) filler component, which is, for example, formed fibrous and/or particulate.

In contrast to dip coating, for example, the at least one reaction material is applied to the at least one contact element section and/or to the at least one contact area section by supplying the at least one reaction material, in particular by means of a distribution tool for distributing the at least one reaction material.

It is possible that the at least one protective element defines a creepage distance between a first pole and a second pole of the at least one cell unit. The creepage distance can be a shortest distance between the first pole and the second pole along the active surface of the at least one protective element.

This means that the occurrence of leakage currents can be prevented or at least significantly reduced by the appropriate configuration of the at least one protective element.

According to a second general aspect, the present disclosure relates to a method for producing an energy supply device for an electric machine, the energy supply device comprising a plurality of cell units which can be contacted with each other, at least one cell unit comprising at least one contact element for transmitting electrical energy, which is assigned to a contact area of the at least one cell unit; with the method steps: applying, in particular coating, at least one reaction material to at least one contact element section of the at least one contact element and/or to at least one contact area section of the contact area; forming a connection, in particular a substantially material-locking connection, between the applied at least one reaction material and the at least one contact element section, and/or between the applied at least one reaction material and the at least one contact area section; constructing of at least one protective element, in particular at least one substantially dimensionally stable protective element, by the applied at least one reaction material in order to shield, in particular permanently insulate, the at least one contact element section and/or the at least one contact area section in each case from a medium, in particular a dispersion medium in an air, of an environment of the energy supply device, in particular wherein the method is configured for producing the energy supply device as disclosed herein.

The method according to the present disclosure is ensured, for example, by an improved process quality, which is accompanied by an improved product quality of the energy supply device. By applying the at least one reaction material, the shape and thus the dimensions of the at least one protective element can be produced in a targeted manner and adapted to the respective ambient conditions, and the respective sections can be shielded with sufficient geometric precision, which is an advantage over production by means of dip coating, for example.

The application, in particular the coating, of the at least one reaction material, the formation of the connection and/or the construction of the at least one protective element can in each case be carried out and/or take place in combination, essentially simultaneously, partially overlapping in time and/or separated in time, for example depending on the properties of the at least one reaction material.

According to a further aspect of the present disclosure, it can be provided that application of the at least one reaction material comprises at least one of the following: pouring the at least one reaction material, squirting the at least one reaction material, spraying the at least one reaction material, in particular in each case with a distribution tool; and/or depositing the at least one reaction material; in particular in each case in a reaction chamber with a defined positive pressure, a defined negative pressure, a defined humidity, a defined atmosphere and/or a defined vacuum generated therein.

The defined negative pressure in the reaction chamber can be lower than an ambient pressure that is a pressure outside the reaction chamber in the environment of the reaction chamber. The defined negative pressure can be in a range from 1 millibar to 0.01 millibar. A defined vacuum in the reaction chamber can be characterized by a very low, in particular extremely low, pressure (for example less than 0.01 millibar) and/or be essentially free of gaseous media. As an alternative to a defined negative pressure, the reaction chamber can also be characterized by a defined positive pressure.

The distribution tool for distributing the at least one reaction material can, for example, comprise a dosing needle, a spray head and/or a nozzle. In this way, for example, a more precise distribution of the at least one reaction material on/at the at least one contact element section and/or on/at the at least one contact area section can be realized.

It is possible that forming the connection and/or constructing the at least one protective element comprises at least one of the following: generating chemical and/or physical bonds and/or interactions in the at least one reaction material and/or between the at least one reaction material and the at least one contact element section and/or the contact area section, shrinking the applied at least one reaction material, hardening the applied at least one reaction material, solidifying the applied at least one reaction material, vaporizing and/or volatilizing at least a part of the at least one reaction material, in particular at least a part of a reacted (converted) at least one reaction material, and/or at least a part of at least one solvent component of the at least one reaction material depending on at least one of the following properties: a defined pressure, a defined irradiation, a defined temperature and/or a defined humidity, in particular in a reaction chamber for producing the energy supply device or at least one component (for example device, unit and/or element) of the energy supply device. The volatilized at least one part of the at least one solvent component can comprise a low molecular weight component, for example when generating bonds by at least one polycondensation reaction to form macromolecules (polymers) from monomers.

The reaction chamber can, for example, be formed as a drying chamber. The atmosphere can be formed by inert gas to displace air, in particular oxygen.

The at least one reaction material is, in particular, during the application of the at least one reaction material and/or during the construction of the at least one protective element, a material that reacts with itself and/or with its surface, in particular chemically and/or physically. The at least one reaction material can thus assume a different aggregate state during the production of the energy supply device, in particular of the at least one protective element, than in a production state of the energy supply device, in particular of the at least one protective element.

The defined irradiation can comprise rays with a defined wavelength and/or of a defined period of time.

The method can comprise: detecting, in particular with a detection device, a shape and/or a location of the at least one protective element by irradiating at least one marking agent component of the at least one reaction material with light, in particular with UV light, wherein in particular the at least one marking agent component is a fluorescent marking agent component.

The detection device can be a camera device or an ultrasonic device, for example. The marking agent component can be configured to absorb light, in particular UV light, and to emit a portion of the absorbed light.

The method can include: welding and/or soldering the at least one contact element to at least one further contact element, to a busbar of the energy supply device and/or to at least one connection of an automation device of the energy supply device for controlling and/or regulating charging processes and/or discharging processes, in order to form a substantially material-locking connection, in particular in each case outside and/or inside the area of the constructed at least one protective element, and/or by means of a welding tool.

The welding tool can be a laser welding tool, for example. In the case of welding or soldering within the area of the constructed at least one protective element, at least partial removal of the constructed at least one protective element can take place by welding (“welding through”) and/or by soldering.

The at least one connection of the automation device can be arranged on and/or at a circuit board of the automation device and can, for example, be formed as a connection surface that is essentially flat and/or even, or as a connection pin that is pin-shaped or rod-shaped. It is understood that the automation device can comprise at least one plug-in contact element for transmitting electrical energy and/or electrical signals.

According to a further general aspect, the present disclosure relates to an arrangement with an energy supply device and with an electric machine, in particular an electric tool. The energy supply device can be configured as disclosed herein. The electric machine can be configured as disclosed herein.

In order to avoid repetitions, features directed purely to the apparatus of the energy supply device according to the disclosure and/or disclosed in connection therewith should also be regarded as disclosed according to the method and be claimable and vice versa.

### BRIEF DESCRIPTION OF THE DRAWINGS

The embodiments and features of the present disclosure described above can be combined with one another in any manner. Further or other details and advantageous effects of the present disclosure are explained in more detail below with reference to the accompanying figures.

FIG. 1 shows a schematic illustration of a first embodiment of the energy supply device according to the present disclosure.

FIG. 2 shows a section of a cell unit of a second embodiment of the energy supply device according to the present disclosure in a sectional view and in a first state.

FIG. 3 shows the cell unit from FIG. 2 in a second state.

FIG. 4 shows a front view (main view) of a cell unit of a third embodiment of the energy supply device according to the present disclosure.

FIG. 5 shows a front view (main view) of an arrangement with several cell units and contact elements of a third embodiment of the energy supply device according to the present disclosure.

FIG. 6 shows a side view of an arrangement with several cell units and contact elements of a fourth embodiment of the energy supply device according to the present disclosure.

FIG. 7 shows a flow chart of an embodiment of the method according to the present disclosure.

### DETAILED DESCRIPTION OF THE DISCLOSURE

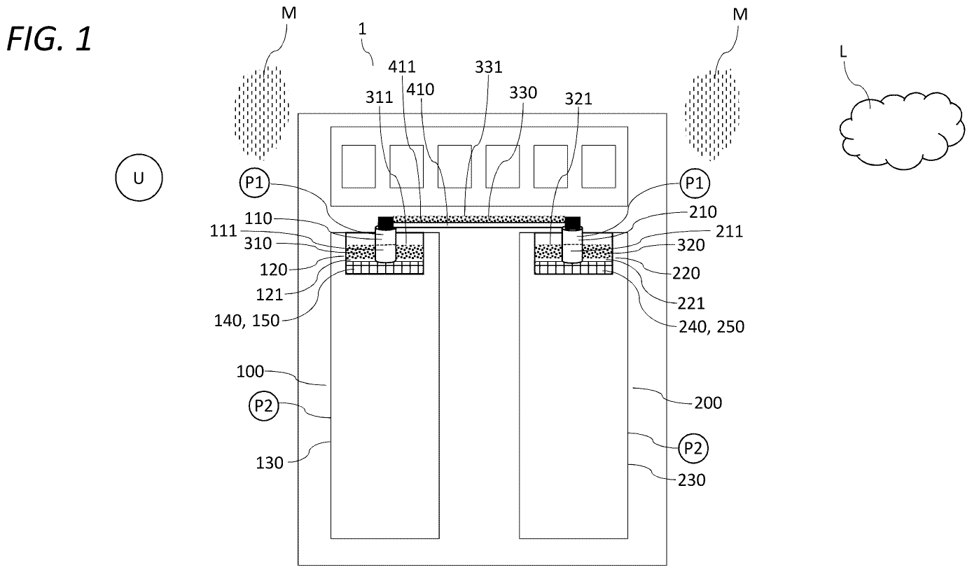

FIG. 1 shows a schematic illustration of a first embodiment of the energy supply device 1 according to the present disclosure.

The energy supply device 1 is configured to supply electrical energy to an electric machine. The electric machine is hidden in the figures for clarity. The electric machine can be a mobile, a portable, a manually operable, and/or a self-sufficient (mains-independent) electric tool (“power tool”). The electric machine can, for example, be configured as one of the following and/or comprise at least one of the following: a garden tool, for example in the form of a mower, a trimmer, a scarifier, a shear, a scythe, a blower; a forestry tool, for example in the form of a chainsaw; a cleaning tool, for example in the form of a high-pressure cleaner; an assembly tool, for example in the form of a drill, a percussion drill, a hammer, a cut-off grinder, a saw; an agricultural tool, for example in the form of a mulcher; a carpentry tool, for example in the form of a planer; a kitchen/household tool, for example in the form of a mixer, a vacuum cleaner, a compressor. Further designs and configurations of the electric machine are possible, for example for the camping sector in the form of a flashlight, a portable radio, etc.

The energy supply device 1 according to the present disclosure is characterized above all by improved protection against a medium M in an air L of an environment U of the energy supply device 1. Depending on the application and environment U of the energy supply device 1, in particular the electric machine with the energy supply device 1, the medium M can be a liquid, a liquid droplet-shaped, a liquid particle-containing medium, and/or a crystal-shaped medium M. The medium M can be dust, for example in the form of crystalline silicates, and/or water in the form of rain, snow, fog or steam. The medium M can represent a harmful medium M with respect to the energy supply device 1 and at least impair its functionality, which will be prevented or at least significantly reduced by the present disclosure.

The energy supply device 1 can be configured to form a detachable plug-in and/or latching connection with the electric machine. The energy supply device 1 can be formed as a mobile, rechargeable accumulator for providing a DC voltage as the supply voltage for the electric machine.

The energy supply device 1 comprises a plurality of cell units 100, 200 of the energy supply device 1 which can be contacted with each other. FIG. 1 shows the cell unit 100 and the cell unit 200 in a representative manner. The plurality of interconnectable cell units 100, 200 can be assigned to and/or taken from a modular system or an assortment. In particular, cell units 100, 200 can be formed essentially identical or similar to each other. Additionally, or alternatively, cell units 100, 200 can be formed at least partially differently from one another.

At least one cell unit 100, 200 can be in the form of a lithium-ion cell unit, sodium-ion cell unit, solid-state cell unit, or lithium-metal cell unit 100, 200. The at least one cell unit 100, 200 can be a standardized cell unit 100, 200, for example, a cylindrical cell unit in the 18650 format. Additionally, or alternatively, the at least one cell unit 100, 200 can be formed, for example, as a so-called pouch cell unit.

The plurality of cell units 100, 200 that can be contacted with each other can be cell units 100, 200 connected in series (one after the other) and/or in parallel in order to provide a defined nominal voltage as the supply voltage of the electric machine. A defined number of cell units 100, 200 that are contacted and/or connected to one another can be formed as a cell module of the energy supply device 1. The energy supply device 1 can, for example, be characterized by a defined electrical power and/or by a defined capacity. The entirety of the cell units 100, 200 can form a so-called core pack of the energy supply device 1 in an interconnected state.

The cell unit 100 and the cell unit 200 are essentially identical to each other, so that the following description is limited to the cell unit 100 in order to avoid repetition. For the sake of simplicity, the term “at least one” is partially omitted below in connection with the description of features.

The cell unit 100 is characterized by a cell housing 130 and comprises a contact area 120 and at least one contact element 110 for transmitting electrical energy. The contact element 110 can form a first electrical pole P1, in particular a positive pole, of the cell unit 100, and the cell housing 130 can form a second electrical pole P2, in particular a negative pole, of the cell unit 100. In other words, the cell housing 130 represents a further contact element of the cell unit 100 and can delimit and/or define the contact area 120 at least in sections.

The contact element 110 is formed from an electrically conductive material based on a metal (for example, essentially copper or essentially aluminum) and/or based on a metal alloy (for example, copper alloy or aluminum alloy). The cell housing 130 is formed from an electrically conductive material based on a metal (for example, essentially copper or essentially aluminum) and/or based on a metal alloy (for example, copper alloy or aluminum alloy). The contact element 110 can be formed substantially flat, plate-shaped, and/or curved, in particular cap-shaped or hood-shaped, pin-shaped, strip-shaped, rail-shaped, beam-shaped, sleeve-shaped, and/or ring-shaped. The cell housing 130 can be formed cylindrically, for example. The contact element 110 and/or the cell housing 130 can each be standardized, that is formed according to a standard.

The contact element 110 is assigned to the contact area 120 of the cell unit 100 and/or is a component of the contact area 120. The contact area 120 can be configured accordingly depending on the configuration of the contact element 110 and/or vice versa. The contact area 120 can be standardized. The contact area 120 can comprise at least one safety element 140, 150. The safety element 140, 150 can, for example, comprise at least one of the following and/or be configured as at least one of the following: a safety valve (pressure relief valve) in the form of a pressure relief valve, a current interruption device (abbreviated as “CID”). The at least one safety element 140, 150 can already be a standard component of the cell unit 100 and/or be formed according to a standard. To ensure proper functionality of the at least one safety element 140, 150 of the contact area 120, it must be appropriately protected against an environment U and here in particular, against a harmful medium M. In addition, the chemical reaction area of the cell unit 100 adjoining the contact area 120 must be protected from a harmful medium M of the environment U. For reasons of clarity, the chemical reaction area of the cell unit 100 is not labelled in more detail in the figures.

The contact element 110 comprises the contact element section 111, which forms a defined section of the contact element 110, in particular within the contact area 120, and/or directly (immediately) or indirectly adjoins and/or connects to the at least one safety element 140, 150. Alternatively, it is possible that the contact element section 111 directly (immediately) adjoins and/or connects to electrodes of the chemical reaction area of the cell unit 100, for example if the cell unit 100 is formed as a so-called tabless cell, in particular as a tabless round cell.

Both the contact area section 121 and the contact element section 111 represent a safety-critical zone of the cell unit 100 and are to be shielded from a medium M (for example, water, dust, and the like) of the environment U as a harmful medium M, in particular to be permanently insulated.

To realize a protective function, that is shielding function, the cell unit 100 comprises at least one protective element 310, in particular a substantially dimensionally stable and/or shape-adapted protective element 310, which is formed from at least one reaction material and/or which in particular consists substantially entirely or exclusively of at least one reaction material. In other words, the at least one reaction material forms the protective element 310 as a whole, and no further components and/or elements are required to form the protective element 310. The at least one reaction material can, for example, be a resin-based material (for example, essentially epoxy resin) and/or an elastomer-based material (for example, essentially acrylate). The at least one reaction material can be an electrically insulating material with inherent insulating properties. The at least one reaction material can be a material with improved wetting properties on its surface, in particular with respect to water as medium M.

The protective element 310 is constructed with tool support by at least one application process, in particular by at least one coating process, and by at least one reaction process of the at least one reaction material on and/or at the contact element section 111, and on and/or at the contact area section 121, and forms a connection, in particular a substantially material-locking connection, with the contact element section 111 and the contact area section 121, in order to shield these in each case from a medium M of the environment U of the energy supply device 1, in particular to insulate them permanently.

To form the protective element 310, the at least one reaction material can be a tool-supported applied and/or condition-modified powder coating, wherein particles (molecules) of the at least one reaction material itself form physical and/or chemical bonds and/or interactions with each other, with the contact element section 111 and/or with the contact area section 121.

The protective element 310 itself forms an immediate (direct) connection with the respective sections 111, 121 in order to shield them accordingly against a medium M. The protective element 310 is integrally formed in one piece and, in particular, is essentially homogeneous. The protective element 310 can ensure, for example, that a medium M in the form of water droplets does not reach the contact element section 111 shielded by the protective element 310 and/or the contact area section 121 shielded by the protective element 310, whereby on the one hand increased safety is provided and on the other hand the functionality of the at least one existing or present safety element 140, 150 is still ensured. In other words, the present disclosure can, above all, ensure more effective moisture protection and/or dust protection in the energy supply device 1 by which it is characterized. In addition, the present disclosure can, for example, prevent or at least significantly reduce bimetallic corrosion and/or crevice corrosion in the energy supply device 1.

The energy supply device 1 comprises a contact element 410 with the contact element section 411. The contact element 410 is formed essentially flat and plate-shaped and establishes an electrical connection, that is contacting, between the contact element 110 of the cell unit 100 and the contact element 210 of the cell unit 200. It is possible that the contact element 410 is electrically connected to further units and/or elements, for example external contacts, electronic circuits, etc. In other words, the contact element 410 is formed as a cell connector and is assigned to the contact area 120 and the contact area 220 of the cell unit 200. The contact element 410 is formed from an electrically conductive material based on a metal (for example, substantially copper or substantially aluminum) and/or based on a metal alloy (for example, copper alloy or aluminum alloy). The contact element 410 forms a substantially material-locking connection both with the contact element 110 and with the contact element 210. The respective substantially material-locking connection 110, 410 and 210, 410 can, for example, be produced by a welding process, in particular by means of a welding tool, for example in the form of a laser welding tool.

A protective element 330 forms a connection with the contact element section 411, in particular a substantially material-locking connection, in order to shield the contact element 410 from a medium M of the environment U, in particular to permanently insulate it. The protective element 330 is formed on and/or at the contact element section 411 by means of an applied, in particular coated, and constructed at least one reaction material. The at least one reaction material can be configured as disclosed herein.

The protective element 310, 320, 330 can in each case form a barrier, for example a layered or multi-layered barrier, in order prevent the medium M from passing through the protective element 310, 320, 330 to the contact element section 111, 211, 411 and/or to the contact area section 121, 221 and in particular to insulate it electrically. The protective element 310, 320, 330 can be formed as a permanently sealing protective element.

Due to the properties of the at least one reaction material, the respective protective element 310, 320, 330 can comprise an active surface 311, 321, 331 with respect to the medium M, which is configured to substantially repel the medium M upon contact with the medium M, in particular to substantially drain from the respective protective element 310, 320, 330, or to substantially hold the medium M, for example by forming an adhesive bond.

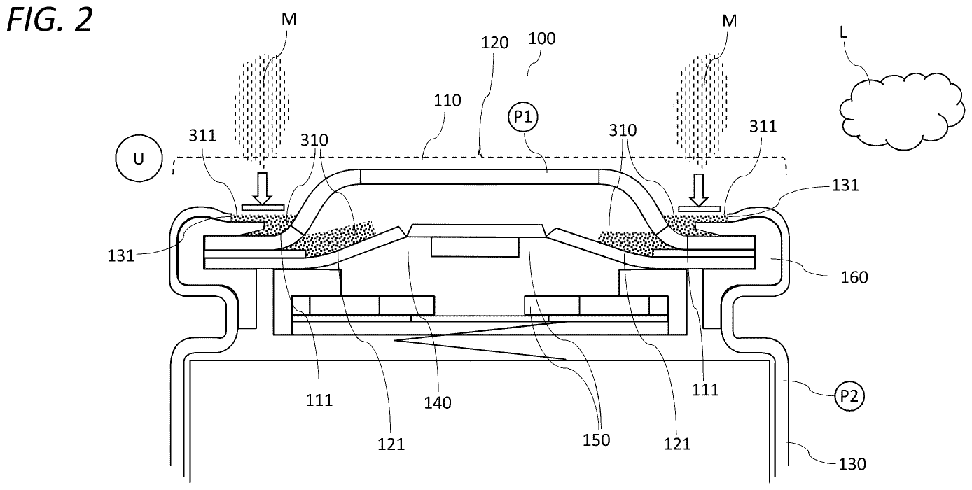

FIG. 2 shows a section of a cell unit 100 of a second embodiment of the energy supply device 1 according to the present disclosure in a sectional view and in a first state. The cell unit 100 is formed in particular as a lithium-ion cell unit (abbreviated “lithium-ion cell”) of a modular system or an assortment with a plurality of cell units.

The cell unit 100, in particular the contact area 120 of the cell unit 100, comprises a safety element 140 in the form of a pressure relief valve with predetermined breaking points. The pressure relief valve 140 is configured to be triggered, that is actuated, when a defined pressure p is reached and/or exceeded inside the cell housing 130 of the cell unit 100, in particular in the area of the chemical reaction chamber, and to bring about pressure equalization in order to prevent destruction of the cell unit 100, for example in the form of an explosion. The cell unit 100, in particular the contact area 120 of the cell unit 100, comprises the safety element 150, which is formed as a current interruption device (CID) and is configured to interrupt a current flow to and/or from the contact element 110 in critical operating situations. Both the safety element 140 and the safety element 150 are located within the cell housing 130 within or in the zone of the contact area 120. The safety element 140 and/or the safety element 150 can each be formed according to a standard, for example according to a standard. In the first state shown, the safety element 150, that is the current interruption device, is open, in particular due to a safety-critical event within the cell unit 100. The safety elements 140 and 150 can be combined with each other or alternatively formed separately from each other.

Alternatively, it is possible that the cell unit 100, in particular the contact area 120, does not itself comprise a safety element 140 and/or a safety element 150 and that these are formed and/or arranged outside the cell unit 100, for example.

The protective element 310 is formed and/or produced as disclosed herein. In particular, the protective element 310 is located in each case between the contact element section 111 of the contact element 110, the contact element section 131 of the cell housing 130 as a further contact element of the cell unit 100 and the contact area section 121 of the contact area 120. The contact area section 121 can be formed in part by the safety element 140 and/or by the safety element 150, that is by respective surfaces of the safety element 140 and/or 150. A sealing element 160 and/or a holding element 160 can be arranged between the contact element 110 and the cell housing 130. Depending on the configuration of the cell unit 100, the sealing element and/or the holding element 160 can, for example, be ring-shaped and/or disk-shaped and/or be formed from a material based on an electrically insulating and/or sealing plastic.

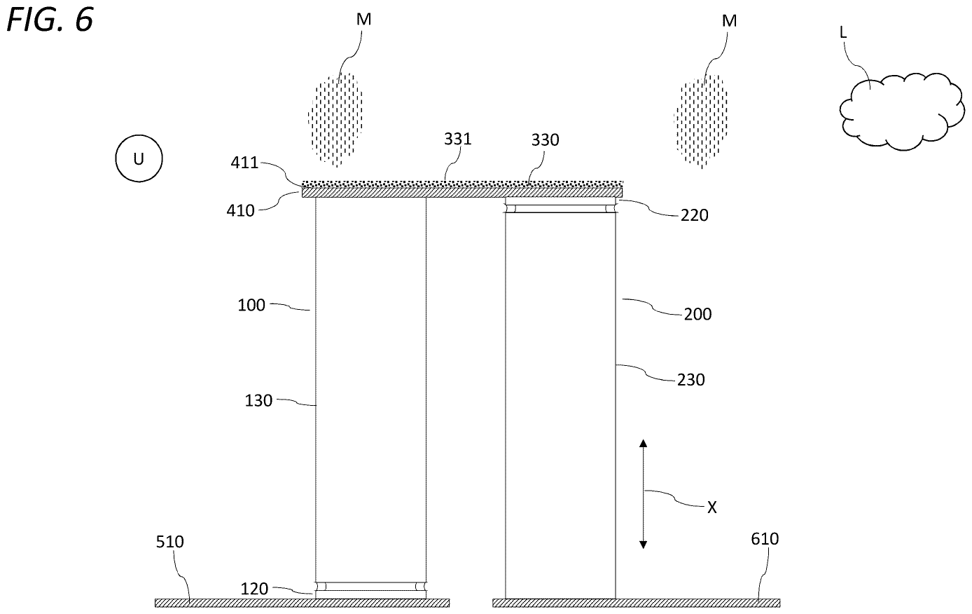

The protective element 310 defines a creepage distance as, in particular, the shortest distance between the contact element 110 as the first pole P1 (positive pole) and the cell housing 130 with the contact element section 131 as the second pole P2 (negative pole). The protective element 310 comprises an active surface 311, which can be configured as disclosed herein. Among other things, the protective element 310 shields the contact element section 131. It is understood that the contact element section 111 and/or the contact element section 131 can each be at least partially differently configured and/or at least partially differently oriented and/or at least partially differently positioned. The protective element 310 can partially or substantially completely shield the cell housing 130 in a view in an extension direction X (longitudinal direction) of the cell unit 100 (see also FIG. 6), in particular in a front view, which is accompanied by a corresponding formation and/or location of the contact element section 131.

The cell unit 100 can be formed as a so-called tabless cell, in particular as a tabless round cell, without (additional) metal tab connections between electrodes and the contact element 110, for example according to EP 3 878 029 A1 (“Cell with a tabless electrode”).

It is understood that the energy supply device 1 comprises further units, devices and/or elements in order to realize an intended functionality, such as a housing, a plug-in section, external connection contact elements, a display unit with at least one display element, for example in the form of a light-emitting diode, etc. However, these are hidden and/or not labelled for reasons of clarity.

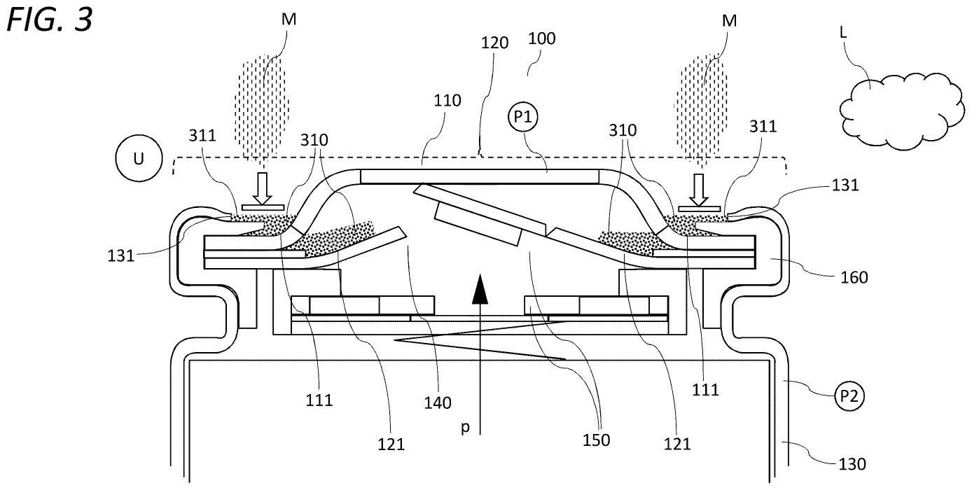

FIG. 3 shows the cell unit of FIG. 2 in a second state, in which a defined pressure p within the cell housing 130, in particular in the area of the electrodes and thus in the chemical reaction area, has been reached and/or exceeded and the pressure relief valve 140 has been actuated by activating a predetermined breaking point in order to achieve pressure equalization and, for example, to prevent an explosion of the cell unit 100.

FIG. 3 shows that despite the arrangement and/or formation of the protective element 310, the functionality of other existing or present safety elements 140, 150 can still be guaranteed and this is in no way impaired by the protective element 310. Furthermore, the safety elements 140, 150 are better protected by the protective element 310, especially with regard to moisture (water).

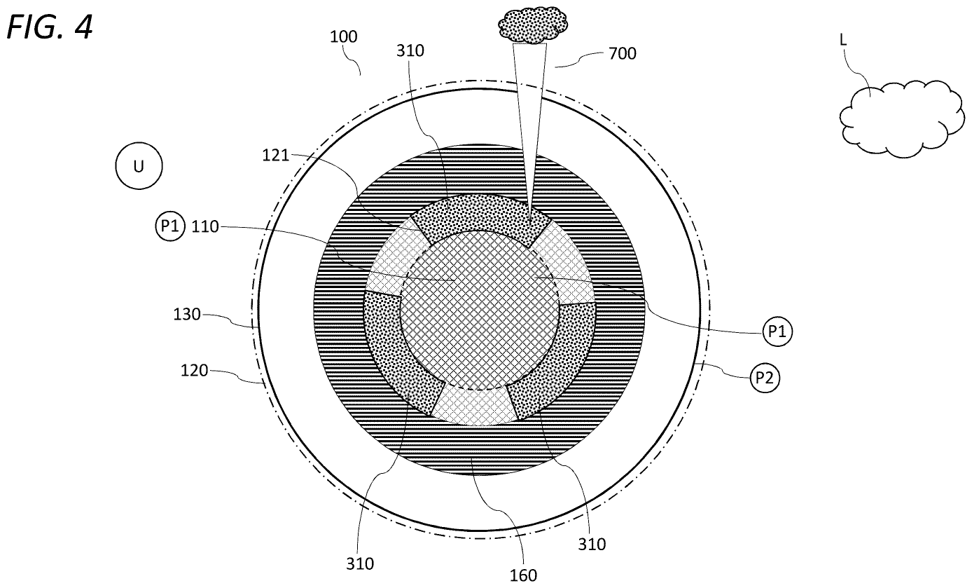

FIG. 4 shows a front view (main view) of a cell unit 100 of a third embodiment of the energy supply device 1 according to the present disclosure. The cell unit 100 is formed as a lithium-ion cell unit and is characterized in the front view by a substantially circular cross-section. The cell unit 100 can be formed according to the 18650 format and have a diameter of approximately 18 mm and a length of approximately 65 mm.

The contact element 110 is formed cap-shaped as a so-called pole cap and is characterized by three arcuate segment-shaped recesses arranged around the circumference, so that the view in FIG. 4 shows three arcuate segments of the contact element 110, which extend into the contact area 120 of the cell unit 100. The contact area 120 of the cell unit 100 is labelled with a dash-dotted line in the illustration in FIG. 4. However, the three recesses in the contact element 110 allow the protective element 310 formed underneath or behind it and made of at least one reaction material, which is produced, for example, by at least one pouring process, squirting process or spraying process, to be seen. The contact area section 121 shielded by the protective element 310 is only indicated by the reference sign 120. The ring-shaped or disk-shaped sealing element 160 between the cell housing 130 and the contact element 110, which covers in sections the three arcuate segments of the contact element 110, is clearly visible.

FIG. 4 shows a schematic illustration of a component of a distribution tool 700 for distributing the at least one reaction material for forming the protective element 310 on and/or at the contact element section 111, and/or on and/or at the contact area section 121.

The distribution tool 700 for distributing the at least one reaction material is configured for applying, in particular for coating, the at least one reaction material and for this purpose comprises, for example, a dosing needle, a spray head or a nozzle, with which a precise and/or exact distribution of the at least one reaction material for forming the protective element 310 can be realized, which for example represents an advantage over a corresponding dip coating.

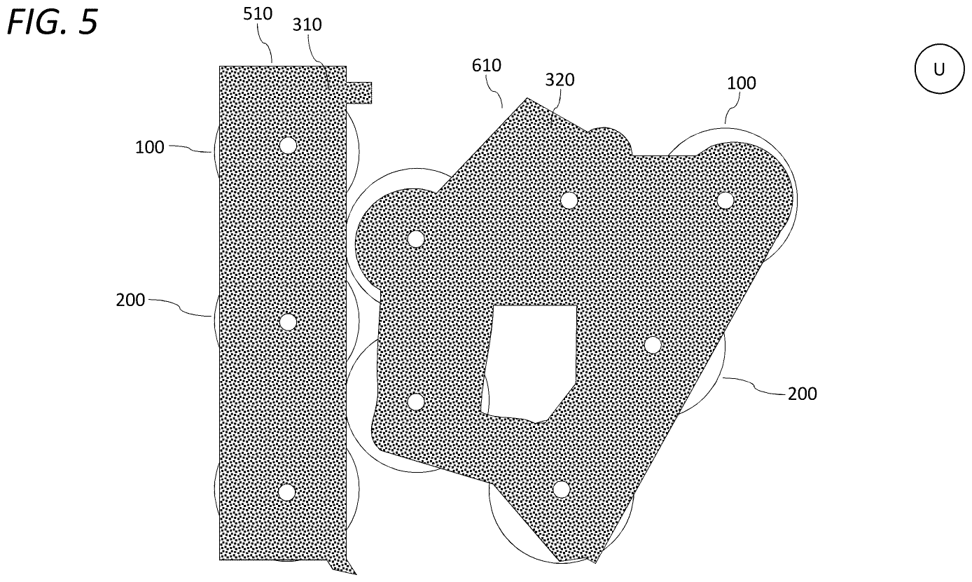

FIG. 5 shows an arrangement with several cell units 100, 200 and contact elements 510, 610 of a third embodiment of the energy supply device 1 according to the present disclosure in a front view (main view), of which the respective cell units 100 and 200 are labelled for reasons of clarity.

The contact elements 510 and 610 are each located outside the cell units 100, 200, but they are assigned to the respective contact areas 120, 220 of the cell units 100, 200 (not visible) and are connected to the respective contact elements 110, 210 of the cell units 100, 200 (not visible) via essentially material-locking connections, in particular welded connections, so that the respective cell units 100, 200 are connected in parallel to one another.

Three cell units 100, 200 are connected to the contact element 510, and six cell units 100, 200 are connected to the contact element 610, of which edges and/or edge areas of five cell units 100, 200 are visible in FIG. 5. Alternatively, more cell units 100, 200 or fewer cell units 100, 200 can be connected to the respective contact elements 510, 610.

On one side and/or on a side of the contact elements 510, 610 facing the environment U, a protective element 310, 320 is formed on respective contact element sections (not visible in FIG. 5), which forms a connection, in particular a substantially material-locking connection, in order to provide shielding of the respective contact element section against a medium M of the environment U.

By producing the protective element 310, 320 according to the disclosure, it is possible to form the protective element 310, 320 geometrically precisely on the respective sections of the contact elements 510, 610, that is to apply, in particular to coat, and/or to construct the protective element 310, 320 by means of the at least one reaction material and, for example, to omit intended connection and/or welding zones, that is defined assembly sections at which, for example, a welding process is to be carried out and/or has been carried out. This eliminates or at least reduces the need to mask connection and/or welding zones, for example by means of a film and/or adhesive. Both a mechanical connection and an electrical connection with improved quality can be realized. Furthermore, the protective element 310, 320 with the at least one reaction material can also adequately shield edge areas and/or edges of the corresponding contact element sections without, for example, edge alignment occurring.

FIG. 6 shows a side view of an arrangement with two cell units 100, 200, in particular in the form of lithium-ion cell units, and contact elements 410, 510, 610 of a fourth embodiment of the energy supply device 1 according to the present disclosure.

The contact element 410 is formed essentially flat and/or plate-shaped as a cell connector and establishes an electrical connection, that is contacting, between the cell unit 100 and the cell unit 200 in the form of a series connection. The cell units 100, 200 extend substantially in the extension direction X and are each characterized by a substantially cylindrical cell housing 130. The cell housing 130 can be encased on the outside by an electrically insulating plastic (insulating material). The cell units 100, 200 can be formed according to a standard, that is standardized, for example according to the 18650 format.

Analogous to the contact element 410, the contact elements 510 and 610 are formed essentially flat and/or plate-shaped as cell connectors.

The contact element 410 comprises a contact element section 411, on which the protective element 330 is arranged and forms a connection with the contact element section 411, in particular a substantially material-locking connection. The protective element 330 extends to the relevant outer edge of the contact element section 411 and shields it from a medium M on the corresponding side. In other words, the contact element section 411 is sufficiently coated by the at least one reaction material of the protective element 330 so that, for example, no edge alignment occurs.

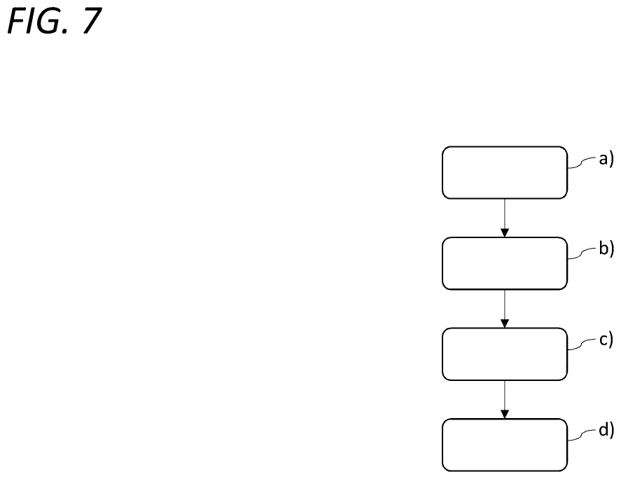

FIG. 7 shows a flow chart of an embodiment of the method according to the present disclosure. In the following, method steps, that is sections and/or phases of the method are described, whereby only partial reference is made to areas, sections, zones, units and/or elements of the energy supply device 1 in order to avoid repetitions. For more detailed illustration, reference is also made to the illustrations in FIGS. 1 to 6 and the associated description.

The method begins in section a) with the application, in particular coating, of at least one reaction material as disclosed herein to and/or on at least one contact element section 111, 211, 411 of the at least one contact element 110, . . . , 610, and/or to and/or on at least one contact area section 121, 221 of the contact area 120, 220 of at least one cell unit 100, 200.

The application can comprise at least one of the following: pouring the at least one reaction material, squirting the at least one reaction material, spraying the at least one reaction material; and/or depositing the at least one reaction material.

The application can take place in a reaction chamber. The reaction chamber can be characterized by a defined negative pressure, a defined humidity, a defined atmosphere and/or a defined vacuum. For example, the reaction chamber can be a drying chamber.

The application is carried out in particular with a distribution tool 700 for distributing the at least one reaction material (see FIG. 4), for example by means of a dosing needle, a spray head or by means of a nozzle.

The at least one reaction material is thus supplied to the respective at least one contact element section 111, 211, 411 and/or to the respective at least one contact area section 121, 221 and applied, in particular coated.

Simultaneously and/or subsequently, in section b), physical and/or chemical bonds are formed between the applied at least one reaction material and these sections 111, . . . , 221 and thus a connection is formed, in particular a substantially material-locking connection, between the applied at least one reaction material and the at least one contact element section 111, 211, 411 and/or between the applied at least one reaction material and the at least one contact area section 121, 221.

Simultaneously and/or subsequently, in section c), the at least one protective element 310, 320, 330 is constructed from the at least one reaction material, in particular by further application by means of the distribution tool 700. Here, the at least one protective element 310, 320, 330 can be constructed as a layered or multi-layered barrier from the at least one reaction material in order to later prevent a medium M from passing through the at least one protective element 310, 320, 330 to the respective sections 111, . . . , 221. By distributing with the distribution tool 700, the at least one reaction material can be defined, that is applied in a targeted manner, in particular applied, at defined points, so that a desired shape of the at least one protective element 310, 320, 330 and/or a desired location of the at least one protective element 310, 320, 330 can be achieved precisely or exactly.

In section d), solidification of the at least one reaction material, in particular hardening, for example by means of a controlled and/or regulated temperature treatment, can take place in order to form the at least one protective element 310, 320, 330 as a whole, by which the energy supply device 1 is then characterized.

The at least one reaction material can be applied, in particular coated, for example in liquid, liquid droplet, gaseous or powder form, and then solidifies to form a substantially dimensionally stable protective element 310, 320, 330, which is formed solely from the at least one reaction material.

The at least one reaction material can, for example, comprise at least one solvent component, wherein at least a part of the at least one solvent component vaporizes and/or volatilizes, in particular depending on at least one of the following properties: a defined pressure, a defined temperature, a defined light quality, and/or a defined humidity.

In addition, the at least one reactive material can comprise at least one marking agent component configured for detection the shape and/or the location and thus the position and/or orientation of the at least one protective element 310, 320, 330. The at least one marking agent component can, for example, be a fluorescent marking agent component. As a result, for example, the formation of the at least one protective element 310, 320, 330 can already be tracked, monitored and/or checked during the production of the at least one protective element 310, 320, 330 by means of a corresponding detection device, for example by means of a camera device of corresponding configuration, in particular by means of a computer-implemented method for image recognition and image processing. This leads, for example, to a further increase in the quality of the manufactured, at least one protective element 310, 320, 330.

During the application, in particular coating, of the at least one reaction material, the formation of the connection, and/or the construction of the at least one protective element 310, 320, 300, the at least one reaction material can essentially react with itself and/or with a surface formed by the at least one reaction material and/or with the respective at least one contact element section 111, 211, 411 and/or with the respective at least one contact area section 121, 221 and form physical and/or chemical bonds. In particular, a transformation of the at least one reaction material can take place during the construction of the at least one protective element 310, 320, 330, which is accompanied, for example, by a change in the aggregate state of the at least one reaction material.

It is possible for the process steps a), b), c) and/or d) described above to be carried out and/or take place in combination, essentially simultaneously, partially overlapping in time and/or separated in time, for example depending on the properties of the at least one reaction material.

The present disclosure is not limited to the embodiments described above. Rather, a large number of variants and modifications are possible, which also make use of the inventive concept and therefore fall within the scope of protection. In particular, the present disclosure also claims protection for the subject matter and features of the subclaims independently of the referenced claims.

### LIST OF REFERENCE SYMBOLS

1 energy supply device
100 cell unit
110 contact element
111 contact element section
120 contact area
121 contact area section
130 cell housing
131 contact element section
140 safety element
150 safety element
160 sealing element, holding element
200 cell unit
210 contact element
211 contact element section
220 contact area
221 contact area section
230 cell housing
240 safety element
250 safety element
310 protective element
311 active surface
320 protective element
321 active surface
330 protective element
331 active surface
410 contact element
411 contact element section
510 contact element
610 contact element
700 distribution tool
L air
M medium
p pressure
P1 first pole
P2 second pole
U environment
X extension direction

What is claimed is:

1. An energy supply device for an electric machine, comprising:
a plurality of cell units configured to be contacted with each other;
at least one cell unit of the plurality of cell units that comprises at least one contact element configured to transmit electrical energy,
wherein the at least one contact element is assigned to a contact area of the at least one cell unit; and
at least one cell unit that comprises at least one protective element formed from at least one reaction material,
wherein the at least one protective element is configured to form a connection with the at least one contact element and/or the contact area to shield at least one contact element section of the at least one contact element and/or at least one contact area section of the contact area from a medium of an environment of the energy supply device.

2. The energy supply device according to claim 1, wherein the at least one protective element is configured as a barrier to prevent passage of the medium through the at least one protective element to the at least one contact element section and/or to the at least one contact area section.

3. The energy supply device according to claim 1,
wherein the at least one protective element comprises an active surface that faces the environment,
wherein the active surface is configured to repel the medium upon contact with the medium or to hold the medium.

4. The energy supply device according to claim 1,
wherein the at least one reaction material comprises at least one solvent component of which at least a part of the at least one solvent component is vaporizable depending on at least one property selected from the group consisting of: a defined pressure, a defined temperature, a defined light quality, a defined period of time, and a defined humidity; or
wherein the at least one reaction material is solvent-free.

5. The energy supply device according to claim 1, wherein the at least one reaction material comprises at least one marking agent component configured to detect a shape, a pattern and/or a location of the at least one protective element.

6. The energy supply device according to claim 5, wherein the at least one marking agent component is a fluorescent marking agent component.

7. The energy supply device according to claim 1, wherein the at least one protective element is configured to partially form a force-locking connection, a predetermined breaking connection, or partially a gas-permeable connection with the at least one contact element section and/or with the at least one contact area section.

8. The energy supply device according to claim 1,
wherein the at least one contact element is at least one shape selected from the group consisting of: flat, plate-shaped, curved, cap-shaped, pin-shaped, band-shaped, rail-shaped, beam-shaped, sleeve-shaped, and ring-shaped;
wherein the at least one protective element at least partially covers the at least one contact element in a circumferential direction.

9. The energy supply device according to claim 1,
wherein the at least one reaction material is applied on the at least one contact element section and/or on the at least one contact area section; or
wherein the at least one reaction material comprises at least one of property, depending on a defined temperature of the at least one reaction material and/or depending on a defined pressure of the at least one reaction material, selected from the group consisting of: pourable, squirtable, sprayable, depositable, sublimable, shrinkable, hardenable, solidifiable, viscous, integrally one-piece, electrically insulating, homogeneous, inhomogeneous, dimensionally stable, and variable in shape.

10. The energy supply device according to claim 1,
wherein the at least one protective element defines a creepage distance between a first pole and a second pole of the at least one cell unit.

11. A method for producing an energy supply device for an electric machine, the energy supply device comprising a plurality of cell units configured to be contacted with each other, at least one cell unit comprising at least one contact element for transmitting electrical energy, wherein the at least one contact element is assigned to a contact area of the at least one cell unit, the method comprising the steps of:
applying at least one reaction material to at least one contact element section of the at least one contact element and/or to at least one contact area section of the contact area;
forming a connection between the applied at least one reaction material and the at least one contact element section, and/or between the applied at least one reaction material and the at least one contact area section; and
constructing of at least one protective element by the applied at least one reaction material to shield the at least one contact element section and/or the at least one contact area section from a medium of an environment of the energy supply device.

12. The method according to claim 11,
wherein the applying step comprises at least one technique selected from the group consisting of: pouring the at least one reaction material, squirting the at least one reaction material, spraying the at least one reaction material, and depositing the at least one reaction material.

13. The method according to claim 11,
wherein the constructing step comprises at least one technique selected from the group consisting of: generating chemical and/or physical bonds and/or interactions in the at least one reaction material, shrinking the applied at least one reaction material, hardening the applied at least one reaction material, solidifying the at least one reaction material, and vaporizing at least a part of at least one solvent component of the at least one reaction material depending on at least one property selected from the group consisting of: a defined pressure, a defined irradiation, a defined temperature, a defined humidity.

14. The method according to claim 11, further comprising the steps of:
detecting a shape of the at least one protective element by irradiating at least one marking agent component of the at least one reaction material with light; or
detecting a location of the at least one protective element by irradiating at least one marking agent component of the at least one reaction material with light.

15. The method according to claim 14,
wherein the light is an UV light; or
wherein the at least one marking agent component is a fluorescent marking agent component.

16. The method according to claim 11, further comprising the step of:
welding the at least one contact element to at least one further contact element, to a busbar of the energy supply device, or to at least one connection of an automation device of the energy supply device for controlling and regulating charging processes and discharging processes to form a material-locking connection.
